(19) United States
(12) Patent Application Publication
(10) Pub. No.: US 2026/0274438 A1
(43) Pub. Date: Sep. 17, 2026

(54) AIRCRAFT TUG ATTACHMENT AND DETACHMENT SYSTEM

(71) Applicant: Utah Valley University, Orem, UT (US)

(72) Inventors: Adam Jim Freeman, Lindon, UT (US); Colby Cowley, Highland, UT (US); Brendan Williams, Provo, UT (US); Brett Stone, Lehi, UT (US); Matthew James Jensen, Salt Lake City, UT (US)

(21) Appl. No.: 19/562,450

(22) Filed: Mar. 10, 2026

Related U.S. Application Data
(60) Provisional application No. 63/770,160, filed on Mar. 11, 2025.

(51) Int. Cl. B64F 1/227

(52) U.S. Cl. CPC B64F 1/227

(57) ABSTRACT

Presented here are embodiments of an innovative aircraft tug attachment and detachment system. Embodiments may include a vertically translatable platform, an azimuth-rotatable cradle, and one or more rotatable latch arms. The cradle's lateral opening aligns with the platform's opening to create an entry path for the aircraft's nose landing gear (NLG). Once the NLG is positioned within the cradle, the cradle may be rotated, and the platform may be lifted off the ground to support the NLG. The rotatable latch arm may then be actuated to secure the NLG. Embodiments provide several advantages, including but not limited to, reducing the number of moving parts, making the system more reliable and easier to maintain, making it easier and faster to use, and minimizing wear on the aircraft's steering system by maintaining a fixed steering position during towing.

### CROSS-REFERENCE TO RELATED APPLICATIONS

This application claims priority to and the benefit of U.S. Provisional Patent Application No. 63/770,160, filed on Mar. 11, 2025, and entitled “AIRCRAFT TUG ATTACHMENT AND DETACHMENT SYSTEM”, the entirety of which is incorporated herein by reference for all purposes.

### BACKGROUND

Aircraft tugs (or simply “tugs”) are specialized ground support equipment used to move aircraft on the ground. Aircraft tugs can be used to reposition aircraft without requiring the aircraft to use its own engines, which can help reduce fuel consumption, minimize noise pollution, and/or improve safety in congested ramp areas. Tugs are often used for pushback maneuvers, where an aircraft is pushed away from an airport gate before taxiing to a runway. Aircraft tugs are also often used for towing aircraft between maintenance areas, storage locations, remote stands, and/or other locations.

The subject matter disclosed and/or claimed herein is not limited to embodiments that operate only in environments such as those described above. Rather, this background is only provided to illustrate one or more example technology areas where some embodiments described herein may be practiced.

It shall be noted that the subject matter discussed in the background section should not be assumed to be prior art merely because of it being mentioned in this background section. Similarly, a problem mentioned in the background section or associated with the subject matter of the background section should not be assumed to have been previously recognized in the prior art. The subject matter in the background section merely represents different approaches, which in and of themselves may also be inventions.

### BRIEF DESCRIPTION OF THE DRAWINGS

References will be made to embodiments of the disclosure, examples of which may be illustrated in the accompanying figures. These figures are intended to be illustrative, not limiting. Although the disclosure is generally described in the context of these embodiments, it should be understood that it is not intended to limit the scope of the disclosure to these particular embodiments. Items in the figures are not necessarily drawn to scale.

FIG. 1 illustrates a conceptual representation of an aircraft tug, in accordance with implementations of the disclosed subject matter.

FIG. 2 illustrates a conceptual representation of an attachment assembly of an aircraft tug, in accordance with implementations of the disclosed subject matter.

FIGS. 3 through 8 illustrate conceptual representations of operations associated with attachment of aircraft nose landing gear to an attachment assembly of an aircraft tug, in accordance with implementations of the disclosed subject matter.

FIG. 9 illustrates a conceptual representation of an aircraft tug configured for engagement with dual-wheel nose landing gear (NLG), in accordance with implementations of the disclosed subject matter.

FIG. 10 illustrates a conceptual representation of the attachment assembly of the aircraft tug of FIG. 9 positioned to receive dual wheels of a dual-wheel NLG, in accordance with implementations of the disclosed subject matter.

FIG. 11 illustrates the attachment assembly of FIG. 10 with the dual wheels positioned within a capture zone of a cradle of the attachment assembly, in accordance with implementations of the disclosed subject matter.

FIG. 12 illustrates the cradle of the attachment assembly rotated relative to a platform to align cradle arms with leading and trailing edges of the dual wheels, in accordance with implementations of the disclosed subject matter.

FIG. 13 illustrates the cradle lifted to engage and support the dual wheels and a latch arm rotated into engagement with the dual wheels, with the cradle further shown in a rotated position relative to the platform for towing operations, in accordance with implementations of the disclosed subject matter.

### DETAILED DESCRIPTION

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system, a device, or a method, which may be implemented, at least in part, using data on a tangible computer-readable medium.

Components, or modules, shown in diagrams are illustrative of example embodiments of the disclosure and are meant to avoid obscuring the disclosure. It shall be understood that throughout this discussion that components may be described as separate functional units, which may comprise sub-units, but those skilled in the art will recognize that various components, or portions thereof, may be divided into separate components or may be integrated together, including, for example, being in a single system or component. It should be noted that functions or operations discussed herein may be implemented as components. Components may be implemented in software, hardware, or a combination thereof.

Furthermore, connections between components or systems within the figures are not intended to be limited to direct connections. Rather, data between these components may be modified, re-formatted, or otherwise changed by intermediary components. Also, additional or fewer connections may be used. It shall also be noted that the terms “coupled,” “connected,” “communicatively coupled,” “interfacing,” “interface,” or similar terms shall be understood to include direct connections, indirect connections through one or more intermediary devices, and wireless connections. The term “operatively coupled” (or similar language) shall be understood to include a coupling that enables transfer of force, motion, torque, power, and/or information between components, whether via direct coupling or via one or more intermediary components. It shall also be noted that any communication, such as a signal, response, reply, acknowledgment, message, query, etc., may comprise one or more exchanges of information.

Reference in the specification to “one or more embodiments,” “preferred embodiment,” “an embodiment,” “embodiments,” “implementation(s)”, “example(s)”, “instance(s)” or the like means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

Any specific embodiment described herein is not necessarily limited strictly to the features expressly described for that specific embodiment and may also (or alternatively) include properties and/or features (e.g., ingredients, components, members, elements, parts, and/or regions) described for one or more separate embodiments. Accordingly, the various features of a given embodiment can be combined with and/or incorporated into other embodiments described herein. Disclosure of certain features relative to a specific embodiment of the present disclosure should not be construed as limiting application or inclusion of said features to the specific embodiment. Rather, it will be appreciated that other embodiments can also include such features.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated. The terms “include,” “including,” “comprise,” “comprising,” or any of their variants shall be understood to be open terms, and any lists of items that follow are example items and not meant to be limited to the listed items. A “layer” may comprise one or more operations. The words “optimal,” “optimize,” “optimization,” and the like refer to an improvement of an outcome or a process and do not require that the specified outcome or process has achieved an “optimal” or peak state. The use of memory, database, information base, data store, tables, hardware, cache, and the like may be used herein to refer to system component or components into which information may be entered or otherwise recorded. A set may contain any number of elements, including the empty set.

Unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

As used in this specification and the appended claims, the singular forms “a,” “an” and “the” do not exclude plural referents unless the context clearly dictates otherwise. Thus, for example, an embodiment referencing a singular referent (e.g., “widget”) may also include two or more such referents.

One skilled in the art shall recognize, in view of the present disclosure, that: (1) certain steps may optionally be performed; (2) steps may not be limited to the specific order set forth herein; (3) certain steps may be performed in different orders; and (4) certain steps may be done concurrently.

Any headings used herein are for organizational purposes only and shall not be used to limit the scope of the description or the claims. Each reference/document mentioned in this patent document is incorporated by reference herein in its entirety.

It shall be noted that any experiments and results provided herein are provided by way of illustration and were performed under specific conditions using a specific embodiment or embodiments; accordingly, neither these experiments nor their results shall be used to limit the scope of the disclosure of the current patent document.

### General Introduction

As noted above, aircraft tugs are used to move aircraft on the ground. There are two main types of airport tugs: conventional tugs and towbarless tugs. Conventional tugs are heavy vehicles that utilize a towbar to connect to the aircraft's NLG. Conventional tugs rely on their substantial weight to generate traction and stability while towing large commercial aircraft. In contrast, towbarless tugs clamp directly onto the aircraft's NLG, allowing for greater maneuverability, quicker attachment and detachment, and reduced risk of towbar failure. Towbarless tugs are increasingly favored for their efficiency and reduced maintenance requirements.

While towbarless tugs can offer some advantages in efficiency and maneuverability, they also come with several challenges. For instance, many towbarless tugs require significant human intervention, such as manual attachment of the NLG to the tug's clamping mechanism or cradle. This process is prone to human errors, and any misalignment or improper securing can result in delays, damage to the aircraft, operational inefficiencies, potential safety risks, or a combination thereof.

Another challenge associated with towbarless tugs is their complexity and the high number of moving parts. Many towbarless tugs utilize numerous hydraulic actuators, lifting mechanisms, and electronic control systems to engage and secure the aircraft's NLG. Each of these components introduces potential failure points and an increased maintenance burden.

Furthermore, the operation of conventional towbarless tugs often necessitates turning the NLG relative to the aircraft during towing maneuvers, which can introduce additional wear on the landing gear assembly. In some cases, excessive rotation or improper handling can lead to strain on the NLG's shock struts, torque links, and/or steering actuators, potentially increasing the frequency of repairs needed on the aircraft itself.

At least one or more disclosed embodiments are directed to an aircraft tug attachment assembly that includes a vertically translatable platform, an azimuth-rotatable cradle connected to the platform, and one or more rotatable latch arms that is/are connected to the cradle. The cradle defines a lateral opening that can selectively align with a lateral opening of the platform when the cradle is rotated into an open position. The aligned lateral openings of the cradle and the platform can define an entry path for an aircraft NLG, which can traverse the entry path to reach a capture zone defined by the cradle (e.g., at the center of the cradle). With the NLG positioned within the capture zone, the cradle may be rotated (in the azimuth direction, or about a vertical axis) such that the lateral opening of the cradle becomes blocked, gated, obstructed, or hidden by the body of the platform, including by becoming circumferentially offset from the lateral opening of the platform about the axis of rotation. Correspondingly, when such rotation of the cradle occurs, the lateral opening of the platform may become blocked, gated, obstructed, or hidden by the body of the cradle. In this regard, an “open” configuration or position may be characterized by alignment of the lateral openings to define the entry path, whereas a “closed” configuration or position may be characterized by nonalignment or circumferential offset of the lateral openings such that at least one of the openings becomes at least partially obstructed.

The rotation of the cradle (with the NLG positioned in the capture zone) may bring cradle arms of the cradle into alignment with the rolling direction of the NLG, such that the cradle arms become positioned about the leading edge and the trailing edge of the tire(s) of the NLG. Under such a configuration, the platform (along with the cradle) may be vertically lifted, causing the NLG tire(s) to rest on the cradle arms and allowing the cradle arms to lift the NLG tire(s) off the ground. The latch arm(s) (which is/are connected to one or more of the cradle arms) may rotate onto the NLG tire(s) to maintain the engagement between NLG tire(s) and the cradle arms (e.g., to prevent or constrain vertical movement of the NLG tire(s)).

With the NLG lifted off the ground and retained by the cradle arms and the latch arm(s), the aircraft tug (to which the attachment assembly is connected) can move the aircraft while allowing the cradle to freely rotate (e.g., to undergo free rotation) relative to the platform, such as rotation that is not actively driven and/or that is not constrained except by friction, braking, stops, and/or other optional constraints. Such a configuration can advantageously allow the NLG to maintain a substantially fixed steering position relative to the rest of the aircraft while being towed, which can mitigate forces/wear on the NLG and/or steering system of the aircraft. Such a configuration can thus avoid or mitigate damage that can result from oversteering aircraft NLG past maximum steering angles during towing and can avoid the need to disconnect (and later reconnect) aircraft steering mechanisms for towing operations (which is often performed manually and is prone to human error).

By utilizing a platform, cradle, and latch arm as described herein, an aircraft tug attachment assembly can utilize relatively few moving parts and actuators. For instance, in one or more examples, rather than implementing horizontally actuating ramps on the cradle to cause engagement between the cradle and the NLG tire(s), a cradle as disclosed herein can engage with the NLG tire(s) via lifting of the platform after rotation of the cradle to align the cradle arms with the leading and trailing edges of the NLG tire(s). Furthermore, as another example, rather than implementing dedicated actuator-driven closing features to close the lateral opening of the cradle, the cradle opening as disclosed herein may be selectively gated by the body of the platform. Accordingly, an aircraft tug that includes an attachment assembly as described herein can include fewer component parts, fewer potential failure points, and can have a reduced maintenance burden relative to conventional towbarless tugs. Furthermore, by utilizing fewer parts, an aircraft tug that includes an attachment assembly as described herein can be highly amenable to automation.

Having just described some of the high-level features and/or advantages associated with the disclosed embodiments, attention will now be directed to the Figures, which provide supporting illustrations for describing the disclosed embodiments.

### Example Aircraft Tugs and Attachment Assemblies

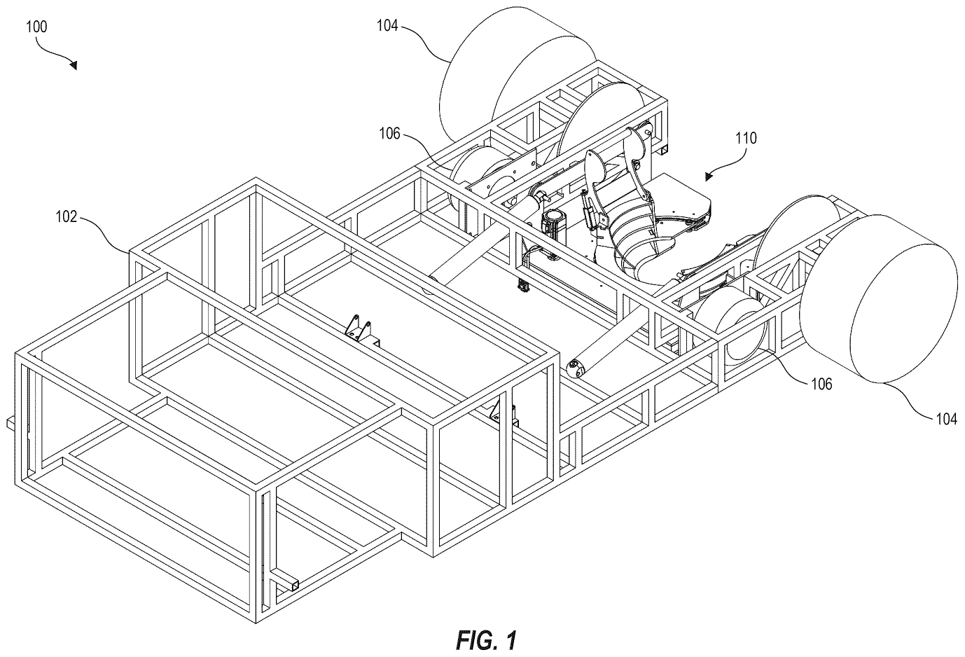

FIG. 1 illustrates a conceptual representation of an aircraft tug 100, in accordance with implementations of the disclosed subject matter. In the example shown in FIG. 1, the aircraft tug 100 includes a frame 102 that supports various components of the aircraft tug 100. For instance, FIG. 1 illustrates wheels 104 (which may comprise ground-engaging drive members and/or ground-engaging members) and drive motors 106 connected to the frame 102. The drive motors 106 can be controlled via one or more control units to drive the wheels 104 to facilitate movement of the aircraft tug 100. An aircraft tug 100 as disclosed herein can include additional or alternative components relative to those shown in FIG. 1 (e.g., steering systems, suspension systems, braking systems, battery packs, hydraulic power units, cooling systems, control consoles, operator interfaces, safety and/or emergency stop systems, load sensors, image sensors, radar/lidar sensors, inertial sensors, orientation sensors, positioning/guidance systems, communication systems, and/or others).

The aircraft tug 100 shown in FIG. 1 further includes an attachment assembly 110 connected to the frame 102, which can facilitate (i) attachment of the aircraft tug 100 to aircraft NLG and (ii) detachment of the aircraft tug 100 from aircraft NLG.

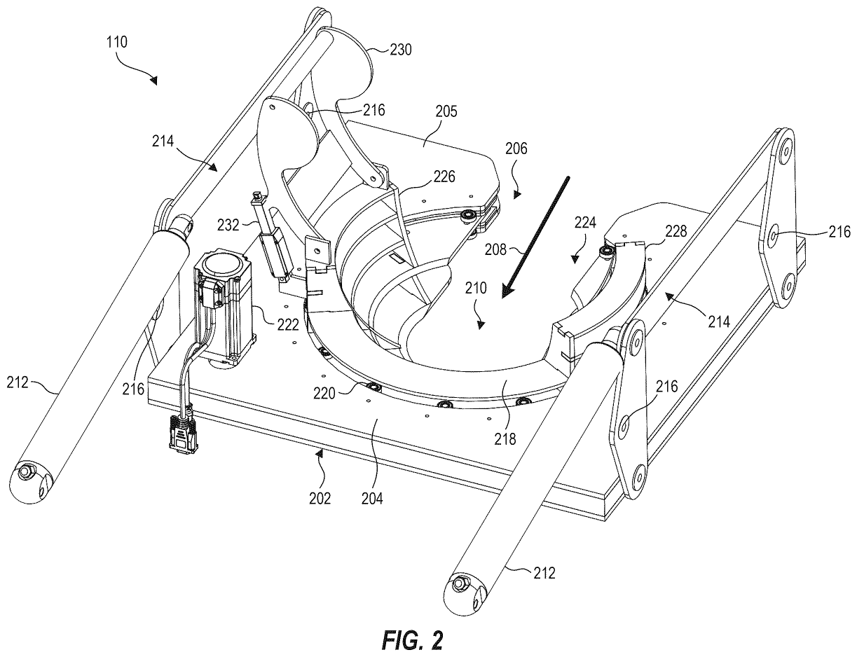

FIG. 2 illustrates a conceptual representation of the attachment assembly 110 of the aircraft tug 100 from FIG. 1, with the frame 102 and other components omitted to more clearly illustrate features of the attachment assembly 110. The attachment assembly 110 shown in FIG. 2 includes a platform 202 that supports other components of the attachment assembly 110 that are configured to interface with aircraft NLG. The platform 202 shown in FIG. 2 includes a platform body 204 that defines a lateral platform opening 206. In some implementations, the platform body 204 may define an upper surface 205 (e.g., a top surface) that faces away from the ground when the aircraft tug 100 is positioned on the ground or floor in its upright orientation. The lateral platform opening 206 can contribute to defining a path 208 for enabling aircraft NLG to enter and exit a capture zone 210 defined by the attachment assembly 110.

In at least one or more embodiments, the platform 202 is translatable relative to the frame 102 (e.g., in the vertical direction). In the example shown in FIG. 2, the attachment assembly 110 includes actuators 212 that can be mounted to the frame 102 and that are connected to linkages 214 that are pivotally mountable to the frame 102 (e.g., at connection points 216), such that actuation of the actuators 212 along their respective axes causes vertical translation of the platform 202 (and the additional components supported thereby) relative to the frame 102. In this regard, the actuators 212 may be operatively coupled between the frame 102 and the platform 202 (and/or the platform body 204) to transfer force and/or motion for causing the vertical translation. One will appreciate, in view of the present disclosure, that alternative mechanisms for facilitating vertical translation of the platform 202 are within the scope of the present disclosure (e.g., lead screw/ball mechanisms, rack/pinion lifts, belt or chain lifts, other types of linear actuators, scissor lift mechanisms, telescoping mechanisms, cable/pulley systems, and/or others).

In the example shown in FIG. 2, the attachment assembly 110 includes a cradle 218 that is rotatably connected (e.g., rotatably coupled) to the platform 202. For instance, the attachment assembly 110 can include a bearing system, such as one or more ball bearings 220 that are connected to the cradle 218 and that are configured to interface with the platform 202, one or more bearing rings/plates that are housed by the platform 202 and that include hardened bearings that support the cradle 218, and/or other bearings. The attachment assembly 110 can further include a mechanism for driving the rotation of the cradle 218. For instance, the attachment assembly 110 shown in FIG. 2 includes a stepper motor 222, which can interface with the cradle 218 (e.g., within the platform 202) to facilitate controlled rotation of the cradle 218 about a central vertical axis (e.g., an axis extending vertically through the capture zone 210).

FIG. 2 illustrates the cradle 218 as defining the capture zone 210 noted hereinabove (e.g., a central opening of the cradle 218 that encompasses or is positioned at or near the axis of rotation of the cradle 218). The capture zone 210 can receive aircraft NLG to facilitate securement of the NLG by the attachment assembly 110. Similar to the platform 202, the cradle 218 shown in FIG. 2 defines a lateral opening 224 that can contribute to defining the path 208 for allowing the NLG to enter and exit the capture zone 210. In the example shown in FIG. 2, the cradle 218 omits a dedicated closing mechanism mounted to the cradle 218 for selectively closing the lateral opening 224 of the cradle 218. The illustrated cradle 218 also omits any closing mechanism that rotates along with the cradle 218 when driven by the stepper motor 222 or other rotation driver. Instead, in one or more embodiments, the attachment assembly 110 leverages the platform body 204 of the platform 202 to facilitate selective closing of the lateral opening 224 when the cradle 218 is rotated from the position shown in FIG. 2. Stated differently, gating of the lateral opening 224 of the cradle 218 (by the platform body 204 of the platform 202) may be achieved by rotation of the cradle 218 to create a closure by nonalignment, circumferential offset, or circumferentially offset positioning of the cradle's lateral opening 224 relative to the platform's lateral opening 206, such that the platform body 204 at least partially obstructs the lateral opening 224 (e.g., obstructing the lateral opening 224). In this regard, an open configuration may be characterized by alignment of the lateral opening 224 and the lateral opening 206 to define the path 208, whereas a closed configuration may be characterized by the circumferential offset/nonalignment that results in at least partial obstruction.

The example cradle 218 shown in FIG. 2 furthermore includes cradle arms 226 and 228 that are configured to interface with an aircraft NLG tire. The cradle arms 226 and 228 can comprise at least partially vertical extensions of the cradle 218 that extend above the platform 202 (e.g., terminating at a height that is higher than the platform 202 when the aircraft tug 100 is positioned on the ground or floor in its upright orientation). As will be shown and/or described in more detail hereinafter, engagement between the cradle arms 226 and 228 can be achieved via vertical translation of the platform 202 (after the NLG tire is positioned at the capture zone 210). Under such a configuration, the cradle 218 can advantageously omit actuators or other features on the cradle arms 226 and 228 that advance inward toward the NLG tire to engage therewith. Although the example shown in FIG. 2 omits such actuators or other features from the cradle arms 226 and 228, they may be included in one or more implementations.

FIG. 2 furthermore illustrates the cradle 218 as including a latch arm 230 that is rotationally connected (e.g., coupled) to the cradle 218. In the example shown in FIG. 2, the latch arm 230 is positioned on one of the cradle arms 226, with the rotational axis of the latch arm 230 being arranged higher than the platform 202 (e.g., higher than an upper surface 205 of the platform body 204) when the aircraft tug 100 is positioned on the ground or floor in its upright orientation. The latch arm 230 can be configured to rotate into engagement with an NLG tire that is positioned in the capture zone 210 and that is in engagement with the cradle arms 226 and cradle arms 228 (e.g., via lifting of the platform 202). The latch arm 230 may be configured to reach a height sufficient to contact the NLG tire on a top half thereof, permitting the latch arm 230 to exert an at least partially downward force on the NLG tire to facilitate retention of the NLG tire.

The attachment assembly 110 may include any suitable means to facilitate movement of the latch arm 230 from an open position (shown in FIG. 2) to a closed position (where the latch arm 230 closes over an NLG tire that is within the capture zone 210 and that is engaged with the cradle arms 226 and 228). In the example shown in FIG. 2, the attachment assembly 110 includes a linear actuator 232 connected to both the cradle 218 and the latch arm 230 such that extension and retraction of the linear actuator 232 causes the latch arm 230 to move between its open and closed positions. Other rotation means for rotating the latch arm 230 are within the scope of the present disclosure. Furthermore, although the example shown in FIG. 2 focuses on rotational movement of the latch arm 230 between its open and closed positions, other movement paths are within the scope of the present disclosure (e.g., a latch arm connected to the cradle 218 may be translated between open and closed positions).

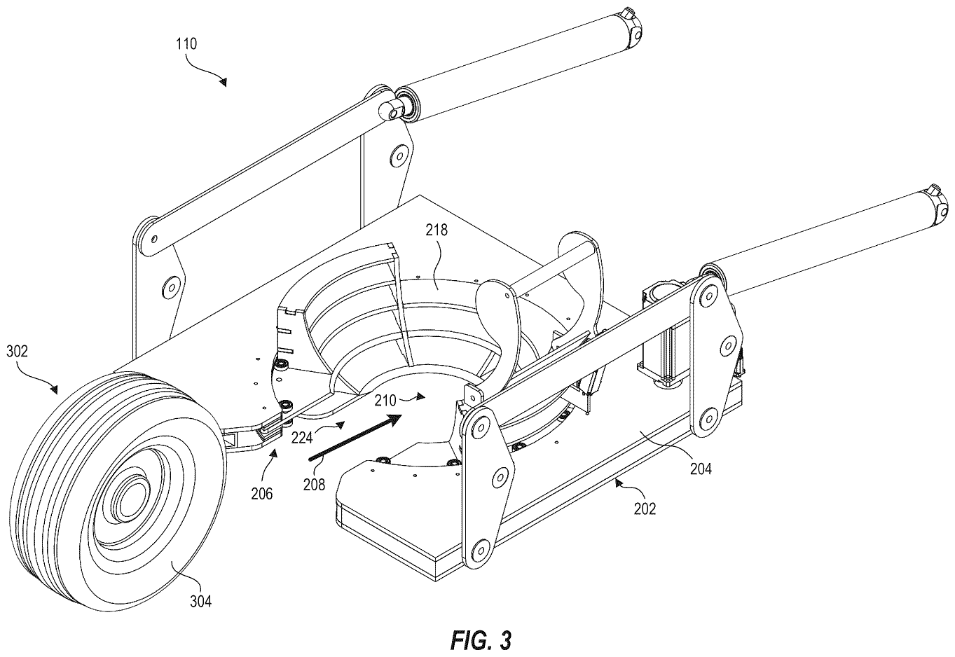

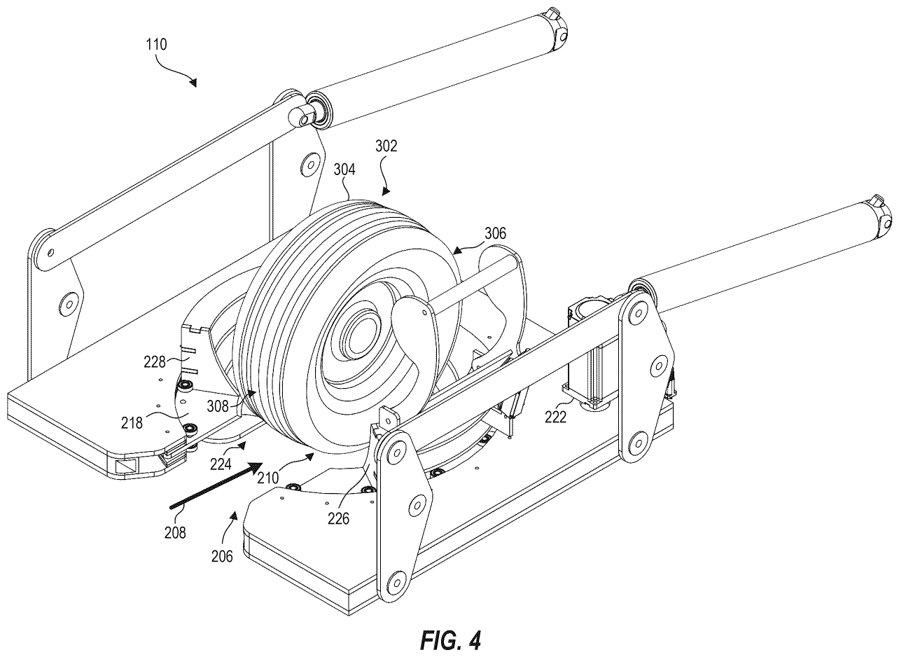

FIGS. 3 through 8 illustrate conceptual representations of operations associated with attachment of aircraft nose landing gear to an attachment assembly 110 of an aircraft tug 100, in accordance with implementations of the disclosed subject matter. FIG. 3 illustrates the attachment assembly 110 shown and described with reference to FIGS. 1 and 2. FIG. 3 furthermore depicts an isolated NLG wheel 302 that includes a tire 304 to illustrate attachment of the NLG wheel 302 to the attachment assembly 110. FIG. 3 illustrates the NLG wheel 302 positioned outside of the capture zone 210 defined by the attachment assembly 110. Pursuant to attaching the attachment assembly 110 to the NLG wheel 302, the NLG wheel 302 may be moved relative to the attachment assembly 110 (e.g., by moving the NLG wheel 302 and/or by moving the aircraft tug 100) to cause the NLG wheel 302 to traverse the path 208 defined by the lateral platform opening 206 and the lateral opening 224 of the cradle 218 to reach the capture zone 210. FIG. 4 illustrates the NLG wheel 302 positioned at the capture zone 210 defined by the attachment assembly 110 (e.g., via movement of the aircraft tug 100 using the drive motors 106 and wheels 104 thereof).

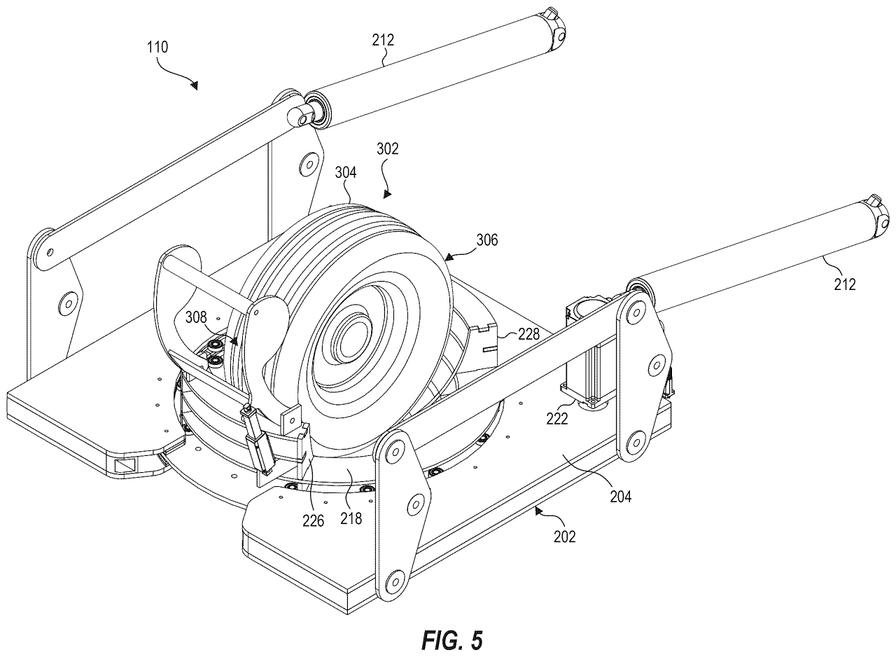

With the NLG wheel 302 positioned at the capture zone 210 as shown in FIG. 4, the cradle 218 may be rotated (e.g., via stepper motor 222) about its rotational axis to bring the cradle arms 226 and 228 of the cradle 218 into alignment with the leading edge 306 and the trailing edge 308 of the tire 304 of the NLG wheel 302. FIG. 5 illustrates the cradle 218 rotated into such a configuration. As noted above, and as illustrated in FIG. 5, rotation of the cradle 218 can cause gating of the lateral opening 224 by the platform body 204 of the platform 202, such that the path 208 previously defined by the lateral platform opening 206 and the lateral opening 224 of the cradle 218 becomes blocked, closed, or obstructed.

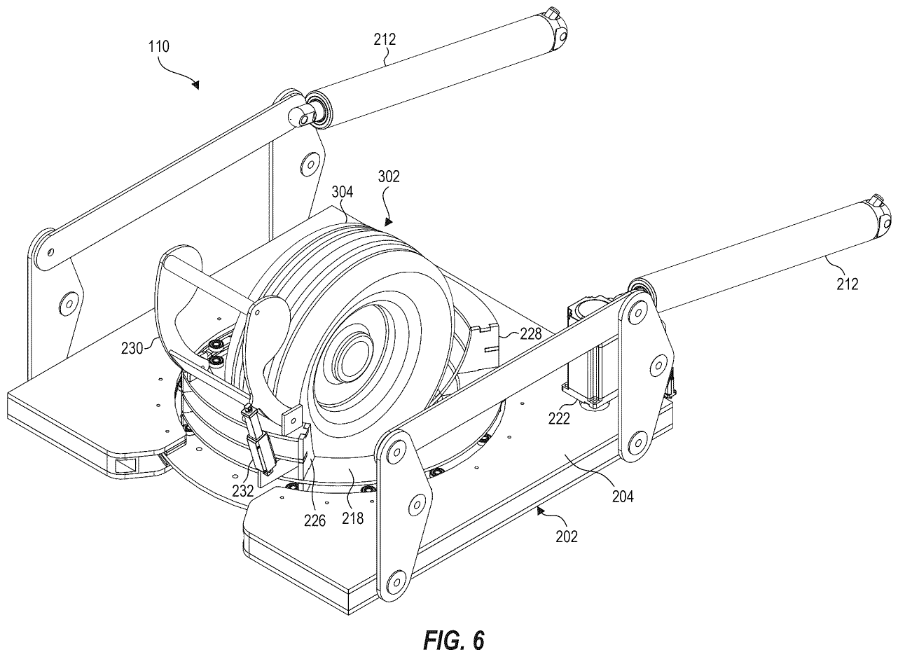

Under the configuration shown in FIG. 5, the platform 202 may be lifted (e.g., via the actuators 212) to bring the cradle arms 226 and 228 into engagement with the tire 304 of the NLG wheel 302. FIG. 6 illustrates the platform 202 lifted relative to the NLG wheel 302 to achieve the engagement between the NLG wheel 302 and the cradle arms 226 and 228. In some implementations, one or more inserts (e.g., at least partially curved inserts) may be placed on the cradle arms 226 and/or 228 or moved inward (manually or via one or more actuators) from the cradle arms to increase the contact area with the tire 304, which can improve load distribution from the NLG wheel 302 to the attachment assembly 110. In some instances, an attachment assembly 110 can be provided with inserts of different sizes to accommodate different tire sizes of aircraft NLG.

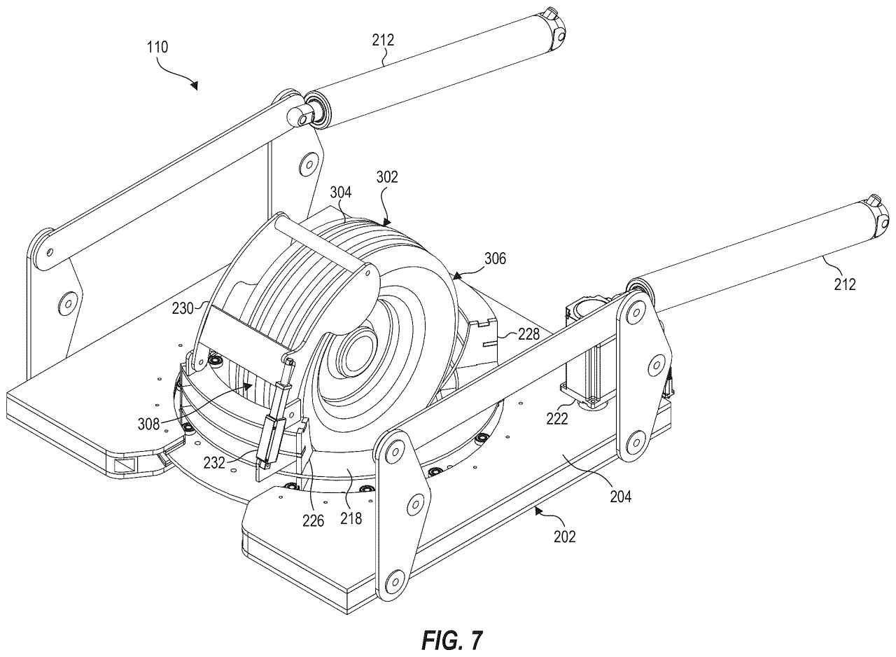

With the NLG wheel 302 lifted by the cradle 218, the latch arm 230 may be actuated (e.g., via the linear actuator 232) to bring the latch arm 230 into engagement with the tire 304 of the NLG wheel 302. FIG. 7 illustrates the latch arm 230 rotated over the tire 304 to secure the NLG wheel 302 to the attachment assembly 110 (e.g., to prevent unwanted vertical and/or lateral movement of the NLG wheel 302 during towing). Under this securement, the aircraft tug 100 may tow the aircraft connected to the NLG wheel 302 to a desired position. In some implementations, the cradle 218 of the attachment assembly 110 may be allowed to freely rotate (e.g., undergo free rotation) during towing operations. Such functionality can enable the NLG wheel 302 to remain in a neutral position relative to the aircraft (e.g., at a center position, or substantially at a zero steering angle) while the aircraft tug 100 turns during towing, which can avoid or mitigate potentially damaging torsional forces on the steering system of the aircraft during towing. In one or more embodiments, the NLG wheel 302 of the aircraft may be turned relative to the aircraft by operators (or automatically) during towing operations.

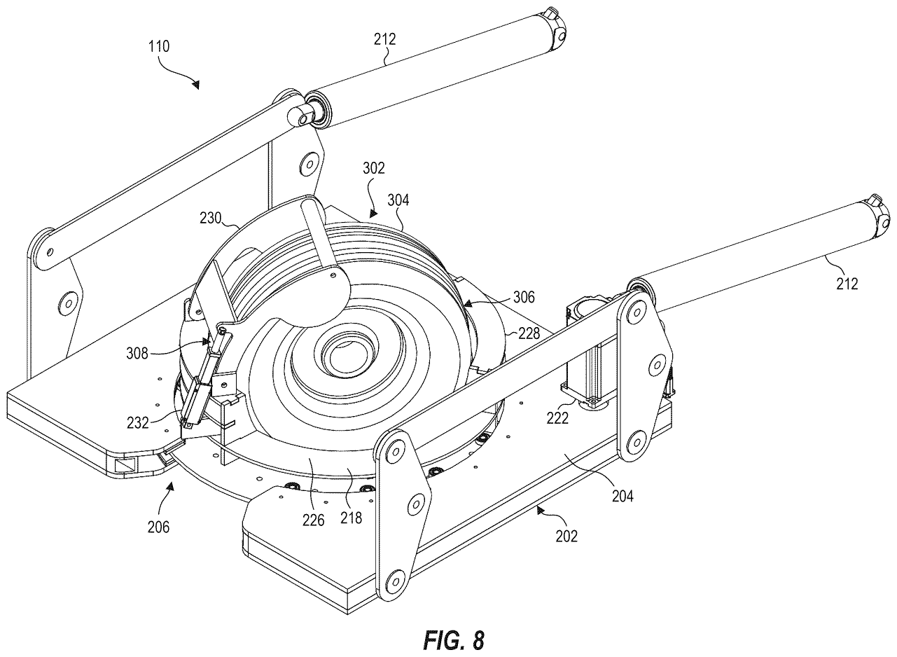

FIG. 8 illustrates the cradle 218 freely rotated to an example turning position while securing the NLG wheel 302 (e.g., during towing). As shown in FIG. 8, during towing, the cradle 218 may become rotated to positions where the lateral platform opening 206 is no longer aligned with the leading edge 306 and/or the trailing edge 308 of the NLG wheel 302, which can achieve turning of the aircraft during towing. In most turning positions, the lateral platform opening 206 will remain unaligned with the lateral platform opening 206 such that the path 208 leading into and/or out of the capture zone 210 does not become established. Even in turning positions where the path 208 becomes established, the engagement between the tire 304 and the latch arm 230 and the cradle arms 226 and 228 (and/or inserts thereon) can safely retain the NLG wheel 302.

After the aircraft tug 100 tows the aircraft to a desired location, the attachment assembly 110 may perform operations to facilitate detachment from the NLG wheel 302. For instance, the cradle 218 may be rotated to cause the lateral platform opening 206 of the platform 202 to become aligned with the leading edge 306 or the trailing edge 308 of the NLG wheel 302 (e.g., similar to the configuration shown in FIG. 7). The latch arm 230 may be actuated out of its closed position to refrain from retaining the NLG wheel 302 (e.g., similar to the configuration shown in FIG. 6), and the platform 202 (along with the cradle 218) may be lowered to allow the NLG wheel 302 to rest on the ground and to disengage the tire 304 from the cradle arms 226 and 228 (e.g., similar to the configuration shown in FIG. 5). One will appreciate, in view of the present disclosure, that the lowering of the platform 202 and/or the opening of the latch arm 230 may be performed in any order. The cradle 218 may then be rotated to a configuration where the lateral opening 224 of the cradle 218 is aligned with the lateral platform opening 206 of the platform 202, thereby establishing or reestablishing the path 208 for the NLG wheel 302 to exit the capture zone 210 (e.g., similar to the configuration shown in FIG. 4). The aircraft tug 100 and/or the NLG wheel 302 may then be moved to facilitate withdrawal of the NLG wheel 302 from the capture zone 210 through the path 208 (e.g., reaching a configuration similar to that shown in FIG. 3).

Although the example aircraft tug attachment assembly 110 illustrated herein has particular dimensions and shape characteristics, disclosed embodiments include aircraft tug attachment assemblies with different dimensions and shape characteristics (e.g., the latch arm(s), the cradle arms, and/or the inserts that are placeable on the cradle arms can have different shapes/sizes to accommodate different NLG wheel and/or tire sizes). Although the example(s) provided herein focus, in at least some respects, on implementations where the attachment assembly 110 is configured to support NLG with a single wheel, disclosed embodiments include aircraft tug attachment assemblies that can support NLG with any quantity of wheels. For instance, the size of the platform, the cradle, and the capture zone defined thereby may be adapted to suit different quantities of NLG wheels, such as dual-wheel configurations (e.g., by widening the cradle and capture zone). Similarly, the cradle arms may be resized and/or the cradle can include any quantity of cradle arms to support any quantity of NLG wheels. Furthermore, any quantity of latch arms may be implemented to facilitate securement of any quantity of NLG wheels. In some embodiments, each respective NLG wheel received by an aircraft tug attachment assembly can be secured by multiple latch arms.

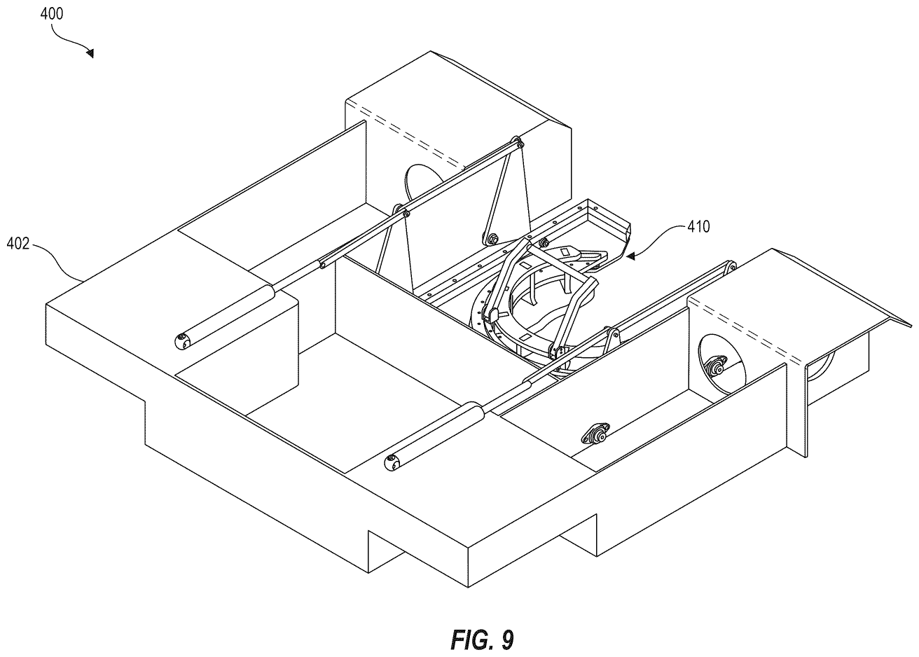

FIG. 9 illustrates a conceptual representation of an aircraft tug 400 that is configured for use with wheels of a dual-wheel NLG. In the example shown in FIG. 9, the aircraft tug 400 includes a frame 402 that supports various components of the aircraft tug 400, as well as an attachment assembly 410 connected to the frame 402. The attachment assembly 410 may be configured to facilitate attachment of the aircraft tug 400 to the wheels of the dual-wheel NLG and detachment of the aircraft tug 400 from the wheels of the dual-wheel NLG. In some implementations, the aircraft tug 400 may include one or more additional or alternative components relative to those expressly shown, such as one or more ground-engaging drive members, drive motors, control units, steering systems, braking systems, power systems, sensing systems, communication systems, and/or operator interface components.

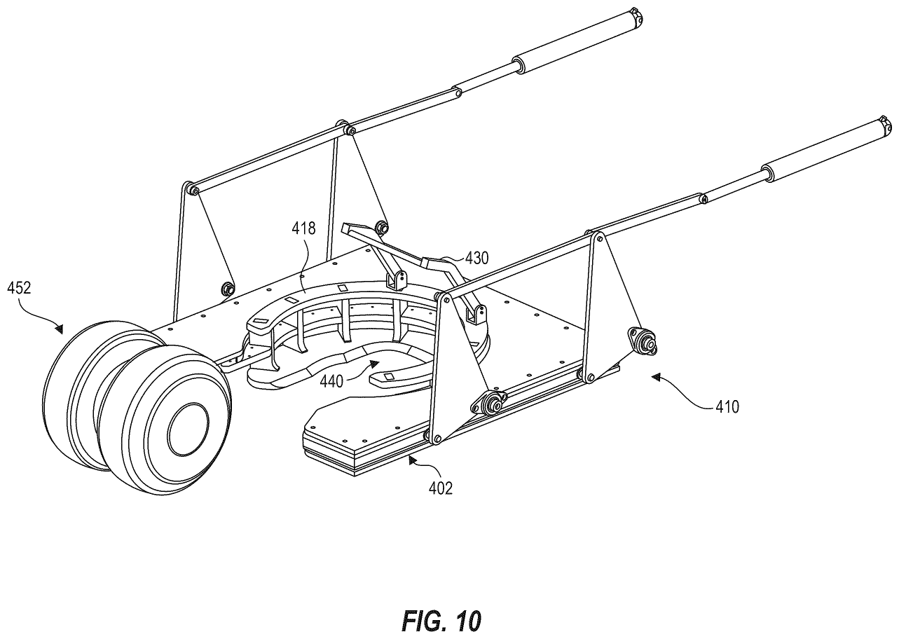

FIG. 10 illustrates a conceptual representation of the attachment assembly 410 of the aircraft tug 400, positioned to receive and engage with dual wheels 452 of a dual-wheel (or twin-wheel) nose landing gear (NLG). In the example shown in FIG. 10, the attachment assembly 410 includes a platform 404 that is similar in structure and function to the platform 202 described above, and a cradle 418 that is rotatably coupled to the platform 404 about a substantially vertical axis, similar to the cradle 218 described hereinabove. The cradle 418 defines a capture zone 440, which is similar to the capture zone 210, and which is configured to receive the dual wheels 452 of the NLG.

The cradle 418 further includes at least one latch arm 430 that is rotatably coupled to the cradle 418, similar to the latch arm 230 described above. The latch arm 430 may be movable between an open position and a closed position to facilitate retention of the dual wheels 452 within the capture zone 440 after engagement by one or more cradle arms of the cradle 418.

As illustrated in FIG. 10, the dual wheels 452 are positioned outside of the capture zone 440, but are aligned with a path into the capture zone 440 defined by aligned lateral openings of the platform 404 and the cradle 418. Under such a configuration, relative movement between the dual wheels 452 and the attachment assembly 410 (e.g., by moving the aircraft tug 400 and/or the aircraft) may cause the dual wheels 452 to traverse the path and enter the capture zone 440 for subsequent engagement and securement.

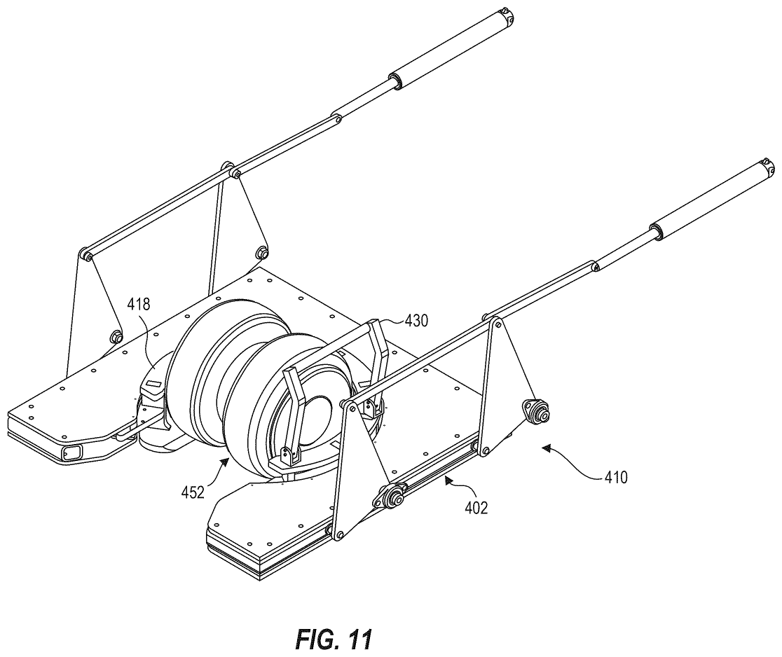

FIG. 11 illustrates the attachment assembly 410 with the dual wheels 452 positioned within the capture zone 440 defined by the cradle 418. In the configuration shown in FIG. 11, the dual wheels 452 have traversed the entry path defined by aligned lateral openings of the platform 404 and the cradle 418 and are now received within the capture zone 440.

With the dual wheels 452 positioned within the capture zone 440, the cradle 418 may be rotated relative to the platform 404 about the substantially vertical axis, as described above with respect to cradle 218 and platform 202. Such rotation may move the cradle 418 from an open configuration toward a closed configuration in which the lateral opening of the cradle 418 becomes circumferentially offset from the corresponding lateral opening of the platform 404. In this regard, the body of the platform 404 may at least partially obstruct the lateral opening of the cradle 418, thereby blocking or gating the entry path into and out of the capture zone 440.

In some implementations, rotation of the cradle 418 with the dual wheels 452 positioned within the capture zone 440 may further bring one or more cradle arms of the cradle 418 into alignment with leading and trailing edges of each of the dual wheels 452. Under such a configuration, the dual wheels 452 may be positioned for subsequent engagement via vertical translation of the platform 404 and the cradle 418 together as a unit, such that the cradle arms engage and lift at least a portion of the dual wheels 452 off of a ground surface. The configuration shown in FIG. 11 thus represents an intermediate capture state in which the dual wheels 452 are received within the capture zone 440 and prepared for secure engagement and lifting by the attachment assembly 410.

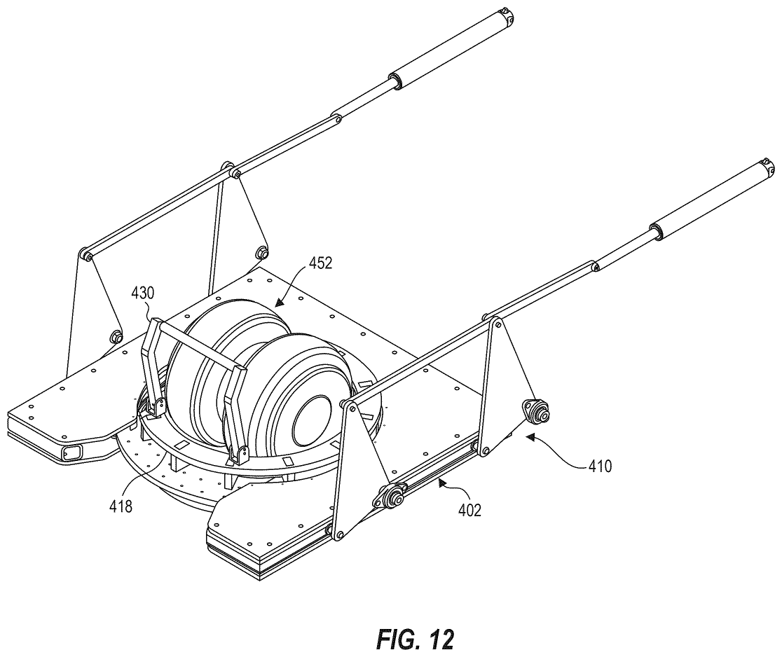

FIG. 12 illustrates the cradle 418 rotated relative to the platform 404. In the configuration shown in FIG. 12, the cradle 418 has been rotated about its substantially vertical axis from an open configuration toward a closed configuration in which a lateral opening of the cradle 418 is circumferentially offset from a corresponding lateral opening of the platform 404. As a result of this circumferential offset, the body of the platform 404 at least partially obstructs the lateral opening of the cradle 418, thereby gating the capture zone 440 and at least partially inhibiting unintended exit of the dual wheels 452.

Rotation of the cradle 418 as shown in FIG. 12 also brings one or more cradle arms of the cradle 418 into alignment with leading and trailing edges of each of the dual wheels 452. In this regard, the cradle arms may be positioned on opposite sides of the dual wheels 452 relative to a rolling direction of the dual wheels 452, such that subsequent vertical translation of the cradle 418 may cause the cradle arms to engage the dual wheels 452 in a load-supporting manner. The latch arm 430 is shown in FIG. 12 in an open position and positioned for rotation into engagement with one or both of the dual wheels 452 (e.g., once lifting has occurred).

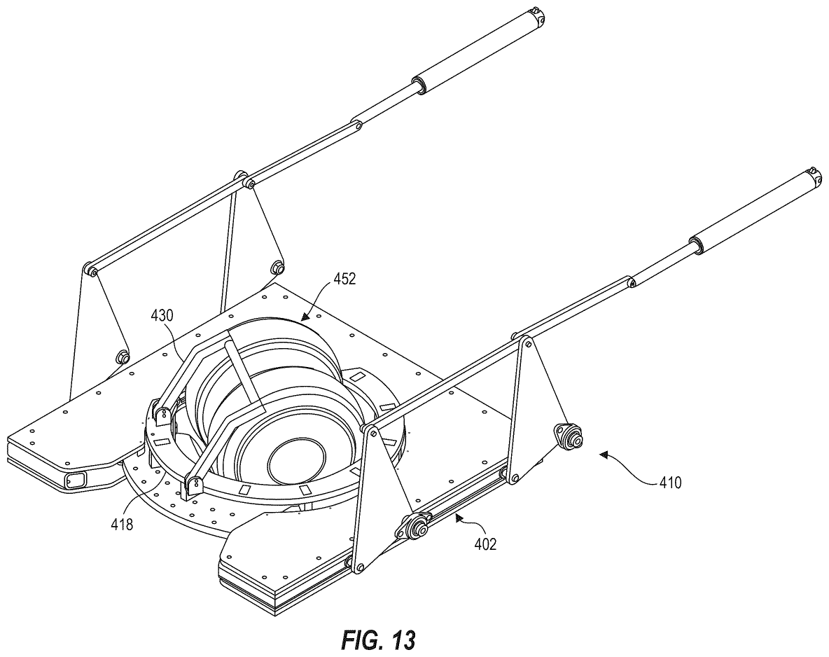

FIG. 13 illustrates the cradle 418 after vertical translation relative to the frame of the aircraft tug 400, such that the cradle arms are brought into engagement with the dual wheels 452 and lift at least a portion of the dual wheels 452 off of a ground surface. In the example shown in FIG. 13, with the dual wheels 452 supported by the cradle arms, the latch arm 430 may be rotated from its open position into a closed position in which the latch arm 430 engages an upper portion of one or both of the dual wheels 452. In some implementations, the latch arm 430 may exert an at least partially downward force on the dual wheels 452 to retain the dual wheels 452 within the capture zone 440 and to inhibit vertical and/or lateral movement during towing operations.

FIG. 13 further illustrates the cradle 418 rotated to yet another rotational position relative to the platform 404 after engagement with the dual wheels 452. Such rotation may occur during towing of the aircraft and may contribute to navigation of the aircraft tug 400 while the dual wheels 452 remain supported and retained by the cradle 418 and the latch arm 430. In some embodiments, the cradle 418 may be configured for free rotation relative to the platform 404 during towing, thereby allowing the dual wheels 452 to maintain a substantially neutral steering position relative to the aircraft while the aircraft tug 400 changes direction.

By utilizing rotation of the cradle 418 to gate the capture zone 440 and by achieving engagement of the dual wheels 452 through vertical translation of the cradle 418 (and/or the platform 404), the attachment assembly 410 may omit complex inwardly actuating clamping mechanisms on the cradle arms. This can reduce the number of moving parts and potential failure points, improve reliability, and/or simplify maintenance. Additionally, permitting rotational freedom of the cradle 418 during towing can mitigate torsional loads on the nose landing gear steering system, thereby reducing wear and potential damage to aircraft components while enabling efficient and controlled towing of aircraft equipped with dual-wheel NLG configurations.

Disclosed embodiments include at least those represented in the following numbered clauses:

Clause 1. An aircraft tug attachment assembly, comprising: a platform body defining a lateral platform opening; and a cradle rotatably coupled to the platform body about a substantially vertical axis, the cradle comprising one or more cradle arms configured to engage with one or more wheels of nose landing gear of an aircraft, wherein: the cradle defines a capture zone configured to receive the one or more wheels, the cradle defines a lateral opening, and the cradle is rotatable between: an open configuration in which the lateral opening of the cradle is aligned with the lateral platform opening to define an entry path into the capture zone, and a closed configuration in which the lateral opening of the cradle is circumferentially offset from the lateral platform opening such that the platform body at least partially obstructs the lateral opening of the cradle.

Clause 2. The aircraft tug attachment assembly of clause 1, further comprising one or more actuators configured to vertically translate at least one of the platform body or the cradle relative to a frame of an aircraft tug.

Clause 3. The aircraft tug attachment assembly of clause 2, wherein the one or more cradle arms are configured to engage with and disengage from the one or more wheels based on vertical translation of the platform body and/or the cradle via the one or more actuators.

Clause 4. The aircraft tug attachment assembly of clause 3, wherein the one or more cradle arms remain vertically fixed relative to the cradle during vertical translation via the one or more actuators.

Clause 5. The aircraft tug attachment assembly of clause 3 or clause 4, wherein the one or more cradle arms are positioned to engage a leading edge and a trailing edge of each of the one or more wheels when the cradle is in the closed configuration.

Clause 6. The aircraft tug attachment assembly of any one of clauses 2 through 5, wherein the cradle remains vertically fixed relative to the platform body during vertical translation via the one or more actuators.

Clause 7. The aircraft tug attachment assembly of any one of clauses 1 through 6, further comprising at least one latch arm coupled to the cradle and configured to retain the one or more wheels within the capture zone.

Clause 8. The aircraft tug attachment assembly of clause 7, wherein the at least one latch arm is rotatable between an open position and a closed position.

Clause 9. The aircraft tug attachment assembly of clause 8, wherein a rotational axis of the at least one latch arm is positioned vertically higher than an upper surface of the platform body.

Clause 10. The aircraft tug attachment assembly of clause 8 or clause 9, wherein, in the closed position, the at least one latch arm is configured to engage a top half of each of the one or more wheels.

Clause 11. The aircraft tug attachment assembly of any one of clauses 8 through 10, wherein the at least one latch arm is configured to exert a downward force on the one or more wheels when in the closed position.

Clause 12. The aircraft tug attachment assembly of any one of clauses 1 through 11, wherein the cradle is configured for free rotation relative to the platform body while the one or more wheels are retained within the capture zone.

Clause 13. An aircraft tug, comprising: a frame; a plurality of ground-engaging drive members supported by the frame; one or more drive motors configured to drive the plurality of ground-engaging drive members; and an attachment assembly coupled to the frame and configured to engage one or more wheels of nose landing gear of an aircraft, the attachment assembly comprising: a platform body defining a lateral platform opening; a cradle rotatably coupled to the platform body about a substantially vertical axis, the cradle comprising one or more cradle arms configured to engage the one or more wheels, wherein the cradle defines a capture zone configured to receive the one or more wheels; and one or more actuators operatively coupled between the frame and at least the platform body, the one or more actuators configured to vertically translate the platform body and the cradle together as a unit relative to the frame, and wherein vertical translation of the platform body and the cradle is configured to cause the one or more cradle arms to engage the one or more wheels within the capture zone.

Clause 14. The aircraft tug of clause 13, wherein the one or more cradle arms are configured to engage a leading edge and a trailing edge of each of the one or more wheels.

Clause 15. The aircraft tug of clause 13 or clause 14, further comprising at least one latch arm coupled to the cradle and configured to retain the one or more wheels within the capture zone after engagement by the one or more cradle arms.

Clause 16. The aircraft tug of clause 15, wherein the at least one latch arm is rotatable between an open position and a closed position, and wherein, in the closed position, the at least one latch arm is configured to engage a top half of each of the one or more wheels.

Clause 17. The aircraft tug of any one of clauses 13 through 16, wherein the cradle is freely rotatable relative to the platform body while the one or more wheels are engaged by the one or more cradle arms.

Clause 18. The aircraft tug of any one of clauses 13 through 17, wherein the cradle defines a lateral opening, and wherein the cradle is rotatable between an open configuration and a closed configuration, wherein the open configuration is characterized by the lateral opening of the cradle aligning with the lateral platform opening to form an entry path into the capture zone, and wherein the closed configuration is characterized by the platform body at least partially obstructing the lateral opening of the cradle.

Clause 19. A method for attaching one or more wheels of nose landing gear of an aircraft to an attachment assembly of an aircraft tug, the attachment assembly including (i) a platform body defining a lateral platform opening and (ii) a cradle rotatably coupled to the platform body and defining a lateral opening and a capture zone, the method comprising: positioning the attachment assembly relative to the one or more wheels such that the lateral opening of the cradle is aligned with the lateral platform opening to define an entry path into the capture zone; causing relative movement between the attachment assembly and the one or more wheels such that the one or more wheels traverse the entry path and enter the capture zone; rotating the cradle relative to the platform body from an open configuration to a closed configuration in which the lateral opening of the cradle is circumferentially offset from the lateral platform opening such that the platform body at least partially obstructs the lateral opening of the cradle; vertically translating the platform body and the cradle together as a unit relative to a frame of the aircraft tug; and engaging the one or more wheels with one or more cradle arms of the cradle via the vertical translation to lift at least a portion of the one or more wheels off of a ground surface.

Clause 20. The method of clause 19, further comprising: lowering the platform body and the cradle to disengage the one or more cradle arms from the one or more wheels; rotating the cradle relative to the platform body to align the lateral opening of the cradle with the lateral platform opening to reestablish the entry path; and causing relative movement between the attachment assembly and the one or more wheels such that the one or more wheels exit the capture zone through the entry path.

It will be appreciated by those skilled in the art that the embodiments described herein are provided by way of example only and are not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claim or claims may be arranged differently including having multiple dependencies, configurations, and combinations.

What is claimed is:

1. An aircraft tug attachment assembly, comprising:
a platform body defining a lateral platform opening; and
a cradle rotatably coupled to the platform body about a substantially vertical axis, the cradle comprising one or more cradle arms configured to engage with one or more wheels of nose landing gear of an aircraft, wherein:
the cradle defines a capture zone configured to receive the one or more wheels,
the cradle defines a lateral opening, and
the cradle is rotatable between:
an open configuration in which the lateral opening of the cradle is aligned with the lateral platform opening to define an entry path into the capture zone, and
a closed configuration in which the lateral opening of the cradle is circumferentially offset from the lateral platform opening such that the platform body at least partially obstructs the lateral opening of the cradle.

2. The aircraft tug attachment assembly of claim 1, further comprising one or more actuators configured to vertically translate at least one of the platform body or the cradle relative to a frame of an aircraft tug.

3. The aircraft tug attachment assembly of claim 2, wherein the one or more cradle arms are configured to engage with and disengage from the one or more wheels based on vertical translation of the platform body and/or the cradle via the one or more actuators.

4. The aircraft tug attachment assembly of claim 3, wherein the one or more cradle arms remain vertically fixed relative to the cradle during vertical translation via the one or more actuators.

5. The aircraft tug attachment assembly of claim 3, wherein the one or more cradle arms are positioned to engage a leading edge and a trailing edge of each of the one or more wheels when the cradle is in the closed configuration.

6. The aircraft tug attachment assembly of claim 2, wherein the cradle remains vertically fixed relative to the platform body during vertical translation via the one or more actuators.

7. The aircraft tug attachment assembly of claim 1, further comprising at least one latch arm coupled to the cradle and configured to retain the one or more wheels within the capture zone.

8. The aircraft tug attachment assembly of claim 7, wherein the at least one latch arm is rotatable between an open position and a closed position.

9. The aircraft tug attachment assembly of claim 8, wherein a rotational axis of the at least one latch arm is positioned vertically higher than an upper surface of the platform body.

10. The aircraft tug attachment assembly of claim 8, wherein, in the closed position, the at least one latch arm is configured to engage a top half of each of the one or more wheels.

11. The aircraft tug attachment assembly of claim 8, wherein the at least one latch arm is configured to exert a downward force on the one or more wheels when in the closed position.

12. The aircraft tug attachment assembly of claim 1, wherein the cradle is configured for free rotation relative to the platform body while the one or more wheels are retained within the capture zone.

13. An aircraft tug, comprising:
a frame;
a plurality of ground-engaging drive members supported by the frame;
one or more drive motors configured to drive the plurality of ground-engaging drive members; and
an attachment assembly coupled to the frame and configured to engage one or more wheels of nose landing gear of an aircraft, the attachment assembly comprising:
a platform body defining a lateral platform opening;
a cradle rotatably coupled to the platform body about a substantially vertical axis, the cradle comprising one or more cradle arms configured to engage the one or more wheels, wherein the cradle defines a capture zone configured to receive the one or more wheels; and
one or more actuators operatively coupled between the frame and at least the platform body, the one or more actuators configured to vertically translate the platform body and the cradle together as a unit relative to the frame, and wherein vertical translation of the platform body and the cradle is configured to cause the one or more cradle arms to engage the one or more wheels within the capture zone.

14. The aircraft tug of claim 13, wherein the one or more cradle arms are configured to engage a leading edge and a trailing edge of each of the one or more wheels.

15. The aircraft tug of claim 13, further comprising at least one latch arm coupled to the cradle and configured to retain the one or more wheels within the capture zone after engagement by the one or more cradle arms.

16. The aircraft tug of claim 15, wherein the at least one latch arm is rotatable between an open position and a closed position, and wherein, in the closed position, the at least one latch arm is configured to engage a top half of each of the one or more wheels.

17. The aircraft tug of claim 13, wherein the cradle is freely rotatable relative to the platform body while the one or more wheels are engaged by the one or more cradle arms.

18. The aircraft tug of claim 13, wherein the cradle defines a lateral opening, and wherein the cradle is rotatable between an open configuration and a closed configuration, wherein the open configuration is characterized by the lateral opening of the cradle aligning with the lateral platform opening to form an entry path into the capture zone, and wherein the closed configuration is characterized by the platform body at least partially obstructing the lateral opening of the cradle.

19. A method for attaching one or more wheels of nose landing gear of an aircraft to an attachment assembly of an aircraft tug, the attachment assembly including (i) a platform body defining a lateral platform opening and (ii) a cradle rotatably coupled to the platform body and defining a lateral opening and a capture zone, the method comprising:
positioning the attachment assembly relative to the one or more wheels such that the lateral opening of the cradle is aligned with the lateral platform opening to define an entry path into the capture zone;
causing relative movement between the attachment assembly and the one or more wheels such that the one or more wheels traverse the entry path and enter the capture zone;
rotating the cradle relative to the platform body from an open configuration to a closed configuration in which the lateral opening of the cradle is circumferentially offset from the lateral platform opening such that the platform body at least partially obstructs the lateral opening of the cradle;
vertically translating the platform body and the cradle together as a unit relative to a frame of the aircraft tug; and
engaging the one or more wheels with one or more cradle arms of the cradle via the vertical translation to lift at least a portion of the one or more wheels off of a ground surface.

20. The method of claim 19, further comprising:
lowering the platform body and the cradle to disengage the one or more cradle arms from the one or more wheels;
rotating the cradle relative to the platform body to align the lateral opening of the cradle with the lateral platform opening to reestablish the entry path; and
causing relative movement between the attachment assembly and the one or more wheels such that the one or more wheels exit the capture zone through the entry path.
